(19) United States
(12) Patent Application Publication
(10) Pub. No.: US 2008/0156138 A1
(43) Pub. Date: Jul. 3, 2008

(54) STEERING APPARATUS

(75) Inventors: Masaki TOMARU, Maebashi-shi (JP); Kouji NAGAI, Maebashi-shi (JP); Kouhei YONEZAWA, Kashiwa-shi (JP)

Correspondence Address: SUGHRUE-265550, 2100 PENNSYLVANIA AVE. NW, WASHINGTON, DC, 20037-3213, US

(73) Assignee: NSK LTD., Tokyo (JP)

(21) Appl. No.: 11/958,417

(22) Filed: Dec. 18, 2007

(30) Foreign Application Priority Data
Dec. 19, 2006 (JP) 2006-340736

(51) Int. Cl. B62D 1/18

(52) U.S. Cl. 74/493

(57) ABSTRACT

When a lower column 3 tilts upwards or downwards, a vehicular front end face 831 of a resin cover 83 having a small friction coefficient tilts slidably along a first guide surface 22A of a left-hand side plate 22 of a vehicle body mounting upper bracket 2. Consequently, since there emerges no situation in which the front end face 831 is caught on the first guide surface 22A of the left-hand side plate of the vehicle body mounting upper bracket 2, a smooth tilt position adjustment can be implemented without any abnormal noise. Further, in secondary collision, the front end face 831 of the resin cover 83 collides with the first guide surface 22A of the left-hand side plate 22 of the vehicle body mounting upper bracket 2, whereby frontward impact force can be transmitted to the vehicle body mounting upper bracket 2 in an ensured fashion.

### BACKGROUND OF THE INVENTION

1. Field of the Invention

The present invention relates to a steering apparatus, and more particularly to a tilt position adjustable electric steering apparatus in which an electric actuator is used as a power supply for adjusting a tilt position of a steering wheel according to the build or driving posture of the driver.

2. Description of Related Art

There is an electric steering apparatus referred to as a tilt type steering apparatus as a steering apparatus in which the vertical position of a steering wheel is adjusted according to the build or driving posture of the driver. In addition, there is an electric steering apparatus referred to as a tilting and telescoping type steering apparatus in which both the vertical and longitudinal positions of a steering wheel are adjusted according to the build or driving posture of the driver.

In these steering apparatuses, since an impact or energy absorbing mechanism for a secondary collision becomes necessary in order to secure safety in collision, a steering column is made to move to the front of a vehicle body in a collapsible fashion by allowing a vehicle body mounting upper bracket to be detached from a vehicle body mounting lower bracket. In addition, by configuring a vehicle body mounting bracket to be made up of separate upper-side and lower-side members, the degree of freedom of a mounting position of the electric steering apparatus to the vehicle body is increased and the weight of the steering apparatus as a whole is decreased.

When the vehicle body mounting upper bracket and the vehicle body mounting lower bracket are configured as the separate members, however, in the event that large vibrations are applied or impact is given to electric steering apparatuses, which are not mounted on vehicle bodies, during transport, a tilt sliding surface between a vehicle body mounting upper bracket and a column slides, and the relative position between the column and the vehicle body mounting upper bracket changes. As a result of this, a positional relationship between a vehicle body mounting surface of the vehicle body mounting upper bracket and the axis of the column is caused to deviate from a predetermined position. Thus, a lot of labor hours are taken to mount the vehicle body mounting upper bracket to the vehicle body.

In an electric steering apparatus described in Japanese Patent Unexamined Publication JP-A-2005-199863, projecting portions are formed on lateral sides of a column so as to project sideways therefrom in a position which lies at a front or rear end of a vehicle body mounting upper bracket. By this configuration, the relative position between the column and the vehicle body mounting upper bracket can be maintained until the vehicle body mounting upper bracket has been mounted on the vehicle body. Therefore, impact force resulting from a secondary collision is made possible to be transmitted to the vehicle body mounting upper bracket in an ensured fashion.

In the electric steering apparatus of JP-A-2005-199863, however, when the column is adjusted with respect to its tilt position in the vehicle body mounting upper bracket, the projecting portions are caught on the vehicle body mounting upper bracket. Thus, there emerges a situation in which a smooth tilt position adjustment is affected badly or abnormal noise is produced. Furthermore, due to the projecting portions being so provided, there has been caused a problem that a lot of labor hours are taken to assemble the vehicle body mounting upper bracket to the column.

### SUMMARY OF THE INVENTION

A problem that the invention is to solve is how to provide a steering apparatus which can maintain the relative position between a column and a vehicle body mounting upper bracket until mounting work of the vehicle body mounting upper bracket on the column is finished and can transmit impact force resulting from a secondary collision to the vehicle body mounting upper bracket in an ensured fashion, wherein not many labor hours are taken to assemble the vehicle body mounting upper bracket on the column, the weight is reduced, and a smooth tilt position adjustment is enabled.

The problem is solved by the following means.

According to a first aspect of the invention, there is provided a steering apparatus including:

a vehicle body mounting bracket adapted to be mounted on a vehicle body;

a column which is supported on left- and right-hand side plates of the vehicle body mounting bracket so as to tilt slidably;

a steering shaft which is supported rotatably in the column and on which a steering wheel is mounted at a vehicular rear side;

a tilt motor;

a tilt drive mechanism for adjusting a tilt position of the column by virtue of a driving force of the tilt motor;

first guide surfaces which are formed on vehicular rear end faces of the side plates and are each formed into an arc shape centered at a tilt center shaft of the column; and

first guided members which are formed on lateral sides of the column and which have first guided surfaces,

wherein the first guided surfaces slide along the first guide surfaces, respectively, at the time of adjusting tilt position of the column.

According to a second aspect of the invention, there is provided the steering apparatus according to the first aspect of the invention, further including first resin covers covering the first guided member and interposed in sliding gaps between the first guide surfaces and the first guided surfaces.

According to a third aspect of the invention, there is provided the steering apparatus according to the first aspect of the invention, wherein

the vehicle body mounting bracket includes:

a vehicle body mounting lower bracket which supports a lower side of the column on the vehicle body so as to pivot about the tilt center shaft as a fulcrum; and

a vehicle body mounting upper bracket which is configured as a separate element from the vehicle body mounting lower bracket and is adapted to mount an upper side of the column on the vehicle body,

wherein the column is held between left- and right-hand side plates of the vehicle body mounting upper bracket so as to tilt slidably.

According to a fourth aspect of the invention, there is provided the steering apparatus according to the second aspect of the invention, wherein the vehicle body mounting bracket includes:

a vehicle body mounting lower bracket which supports a lower side of the column on the vehicle body so as to pivot about the tilt center shaft as a fulcrum; and

a vehicle body mounting upper bracket which is configured as a separate element from the vehicle body mounting lower bracket and is adapted to mount an upper side of the column on the vehicle body; and wherein

the column is held between left- and right-hand side plates of the vehicle body mounting upper bracket so as to tilt slidably.

According to a fifth aspect of the invention, there is provided the steering apparatus according to the first aspect of the invention, wherein

the first guided members are mounted detachably on the column.

According to a sixth aspect of the invention, there is provided the steering apparatus according to second aspect of the invention, wherein

the first guided members are mounted detachably on the column.

According to a seventh aspect of the invention, there is provided the steering apparatus according to the third aspect of the invention, wherein

the first guided members are mounted detachably on the column.

According to an eighth aspect of the invention, there is provided the steering apparatus according to the fourth aspect of the invention, wherein

the first guided members are mounted detachably on the column.

According to a ninth aspect of the invention, there is provided the steering apparatus according to the first aspect of the invention, wherein

the first guided surface is concentric with the first guide surface and is formed into an arc shape which has a radius of curvature which is slightly larger than the first guide surface.

According to a tenth aspect of the invention, there is provided the steering apparatus according to the first aspect of the invention, wherein

the first guided surface is formed into a straight line shape which extends substantially in a tangential direction relative to the first guide surface.

According to an eleventh aspect of the invention, there is provided the steering apparatus according to the first aspect of the invention, further including:

second guide surfaces which are formed on end faces of the side plates which face the front of the vehicle body and are each formed into an arc shape centered at the tilt center shaft of the column;

second guided members which are formed on the lateral sides of the column and which have second guided surfaces adapted to slide along the second guide surfaces, respectively, when the column is adjusted with respect to its tilt position; and

second resin covers covering the second guided members and interposed in sliding gaps between the second guide surfaces and the second guided surfaces.

According to a twelfth aspect of the invention, there is provided the steering apparatus according to the eleventh aspect of the invention, wherein

the second guided members are mounted detachably on the column.

According to a thirteenth aspect of the invention, there is provided the steering apparatus according to the first aspect of the invention, further including:

elongated grooves which are formed on the side plates and are each formed into an arc shape centered at the tilt center shaft of the column; and

third guided members which are formed on the lateral sides of the column and are adapted to along the elongated grooves, respectively, at the time of adjusting the tilt position of the column.

According to a fourteenth aspect of the invention, there is provided the steering apparatus according to the first aspect of the invention, further including:

a spacer interposed between either of the left- and right-hand side plates and the lateral side of the column; and

an adjustment screw which is provided on the side plate, so as to push the spacer towards the lateral side of the column.

In the steering apparatus of the invention, the column is held between the left- and right-hand side plates of the vehicle body mounting bracket so as to tilt slidably, the first guide surfaces are formed on the vehicular rear side end faces of the side plates into the arc shape centered at the tilt center shaft of the column, the first guided members are formed on the lateral sides of the column which have the first guided surfaces which can slide along the first guide surfaces, respectively, when the column is adjusted with respect to its tilt position, and the first resin covers covering the first guided members and interposed between in the sliding gaps between the first guide surfaces and the first guided surfaces. In addition, the first guided members are mounted detachably on the column. Consequently, few labor hours are taken to assemble the vehicle body mounting upper bracket to the column and a smooth tilt position adjustment is enabled.

### BRIEF DESCRIPTION OF THE DRAWINGS

FIG. 1 is an overall perspective view showing a state in which an electric steering apparatus 101 of the invention is mounted on a vehicle;

FIG. 2A is a side view showing a main part of the electric steering apparatus 101 of Embodiment 1 of the invention;

FIG. 2B is a sectional view taken along the line IIB-IIB in FIG. 2A;

FIG. 3 is a sectional view taken along the line III-III in FIG. 2, which shows a tilt siding portion between a vehicle body mounting upper bracket and a lower column;

FIG. 4 is a partially cutaway side view showing a main part of a tilt drive mechanism of the electric steering apparatus 101 of Embodiment 1;

FIG. 5 is a sectional view taken along the line V-V in FIG. 4;

FIG. 6 is a partially cutaway side view showing a main part of a telescoping drive mechanism of the electric steering apparatus 101 of Embodiment 1;

FIG. 7 is a side view showing a main part of an electric steering apparatus of Embodiment 2 of the invention;

FIG. 8 is a side view showing a main part of an electric steering apparatus of Embodiment 3 of the invention;

FIG. 9 is a side view showing a main part of an electric steering apparatus of Embodiment 4 of the invention;

FIG. 10 is a side view showing a main part of an electric steering apparatus of Embodiment 5 of the invention;

### DETAILED DESCRIPTION OF THE PREFERRED EMBODIMENTS

In embodiments which will be described herebelow, the invention will be described as being applied to a tilting and telescoping type electric steering apparatus in which a steering wheel is adjusted with respect to its vertical position, as well as its longitudinal position.

### Embodiment 1

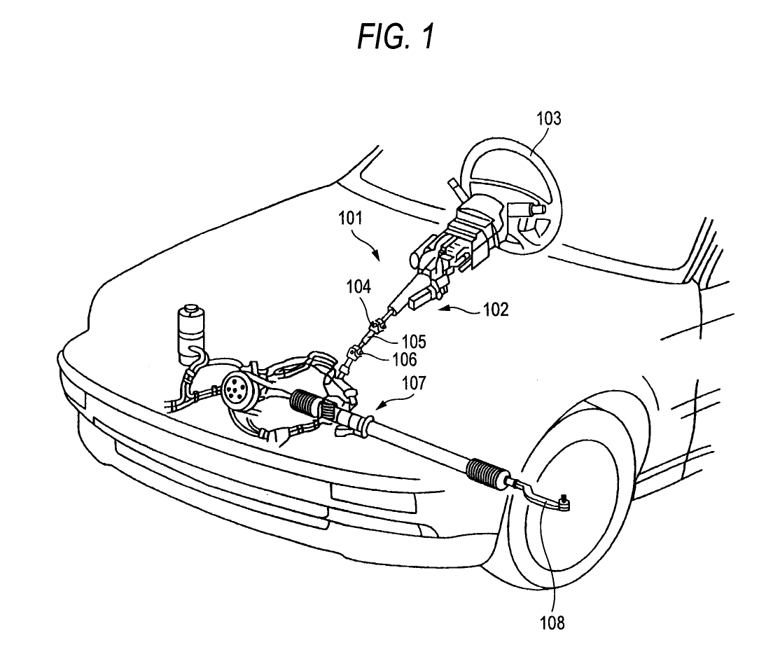

FIG. 1 is an overall perspective view showing a state in which an electric steering apparatus 101 of the invention is mounted on a vehicle. The electric steering apparatus 101 supports a steering shaft 102 rotatably. A steering wheel 3 is mounted on the steering shaft 102 at an upper end (a vehicular rear side) thereof, and an intermediate shaft 105 is connected to a lower end (a vehicular front side) of the steering shaft 102 via a universal joint 104.

A universal joint 106 is connected to a lower end of the intermediate shaft 105, and a steering gear 107, which is made up of a rack-and-pinion mechanism, is connected to the universal joint 106.

When the driver operates to turn the steering wheel 103, a rotational force exerted on the steering wheel 103 is transmitted to the steering gear 107 via the steering shaft 102, the universal joint 104, the intermediate shaft 105 and the universal joint 106, so as to move a tie rod 108 via the rack-and-pinion mechanism to thereby change the turning angle of a steered wheel.

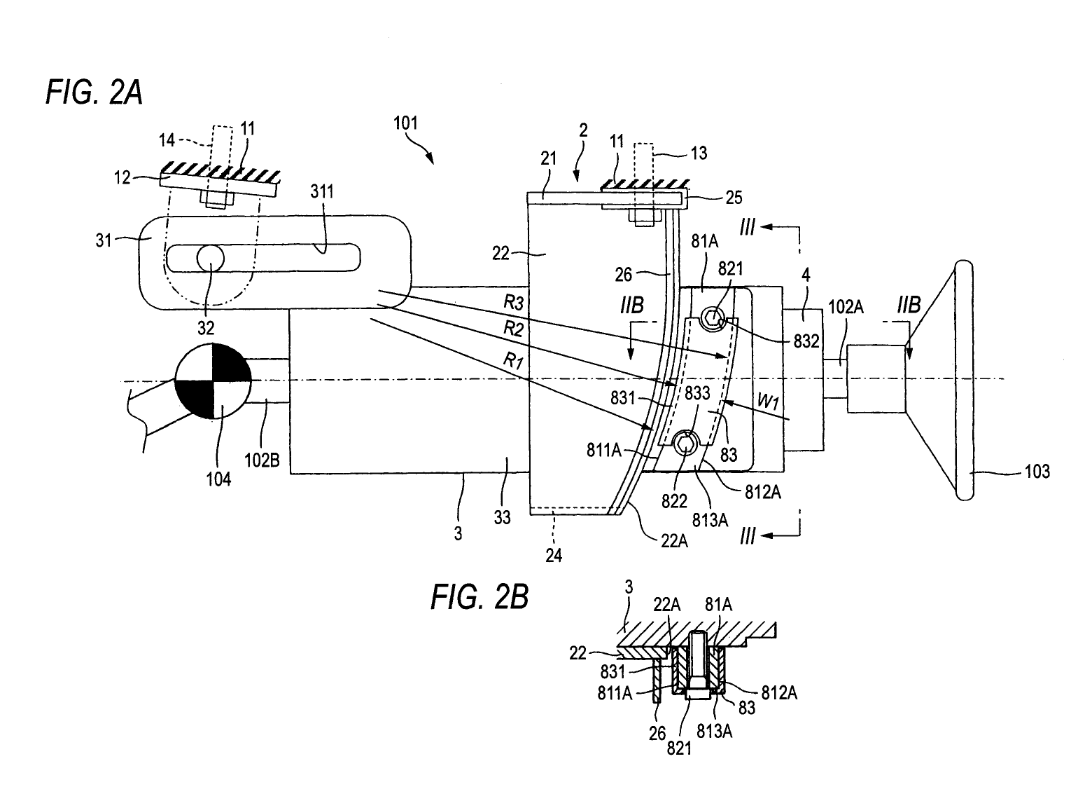

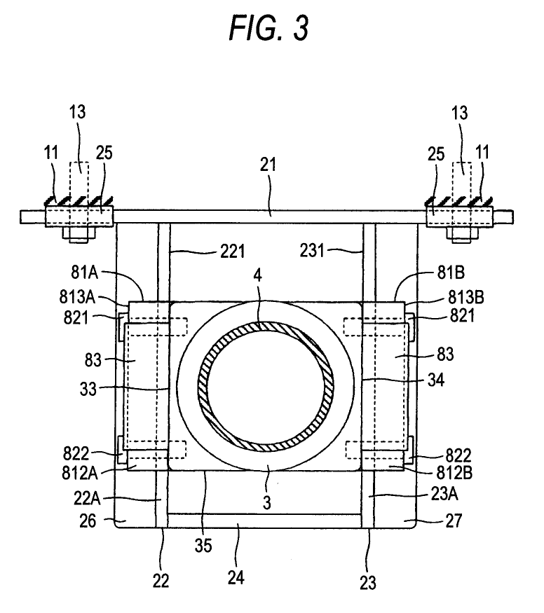

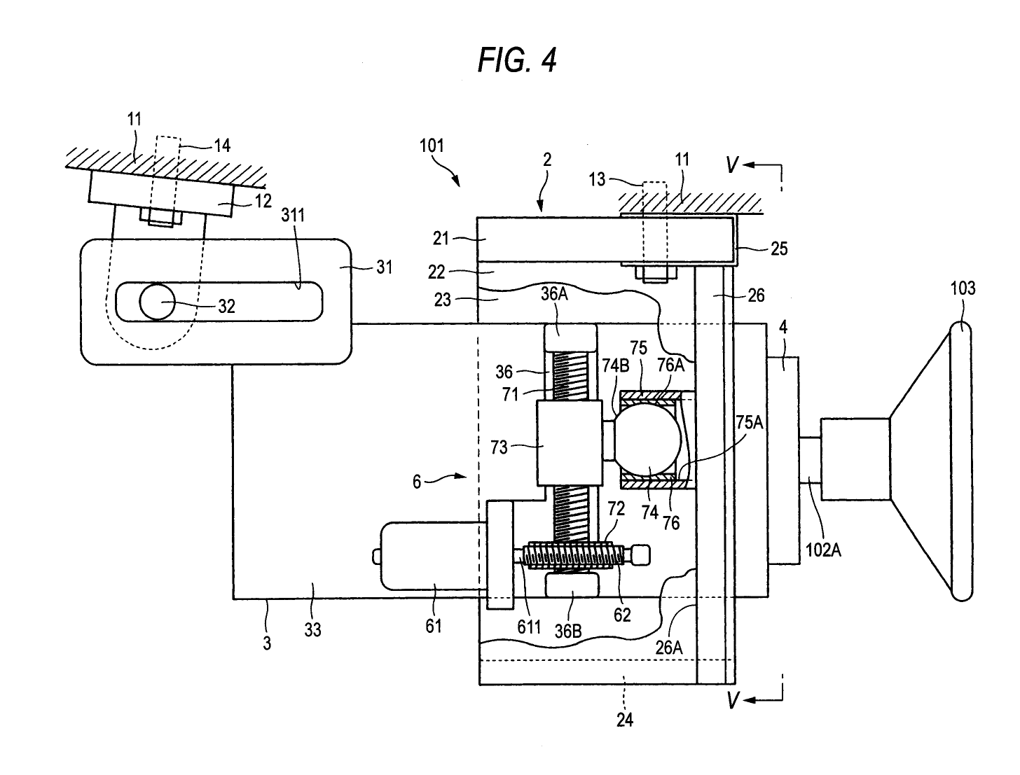

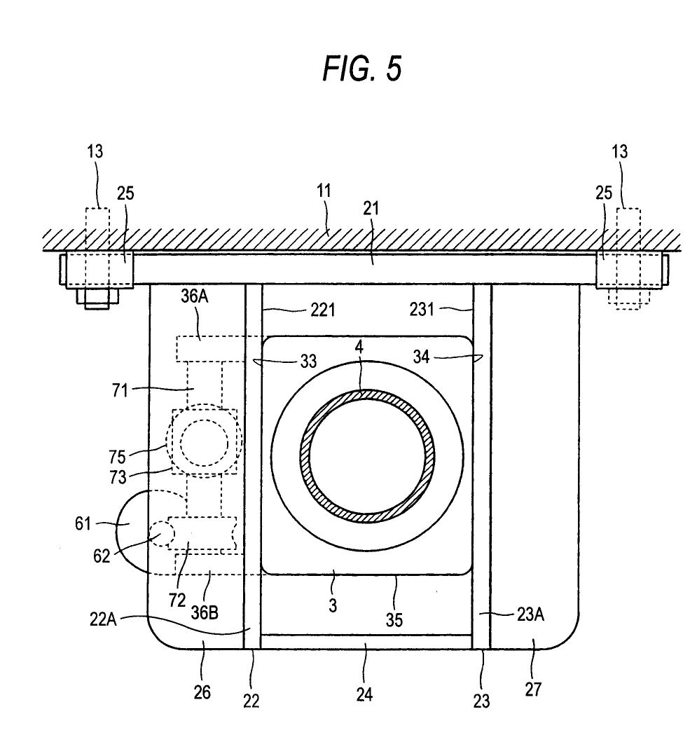

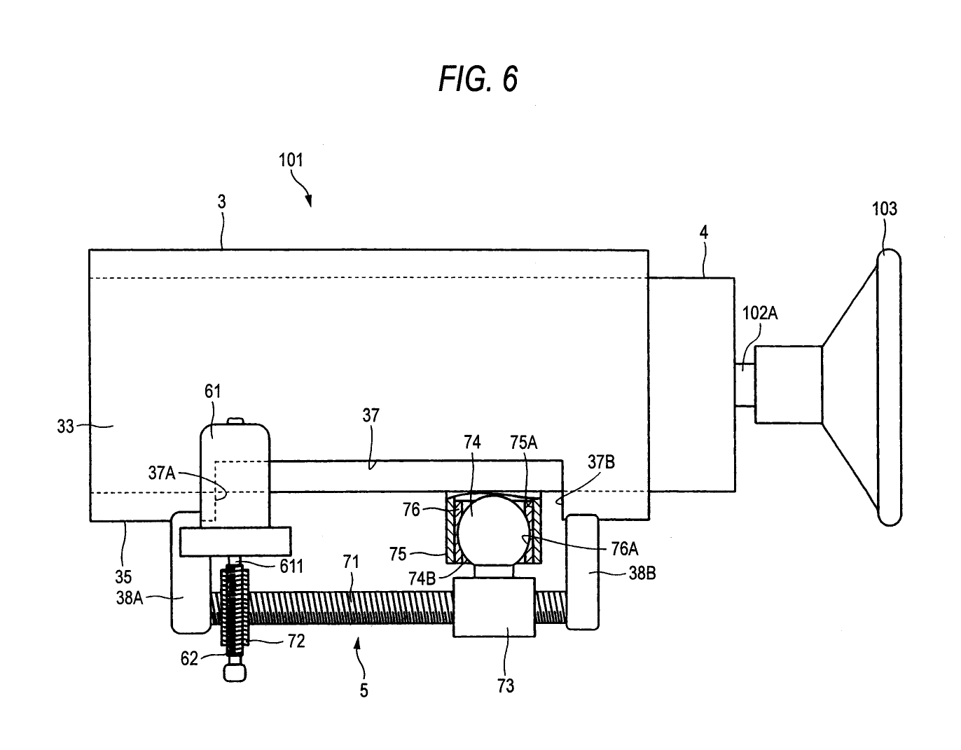

FIG. 2A is a side view showing a main part of the electric steering apparatus 101 of Embodiment 1 of the invention. FIG. 2B is a sectional view taken along the line IIB-IIB in FIG. 2A. FIG. 3 is a sectional view taken along the line III-III in FIG. 2A, which shows a tilt siding portion between a vehicle body mounting upper bracket and a lower column. FIG. 4 is a partially cutaway side view showing a main part of a tilt drive mechanism of the electric steering apparatus 101 of Embodiment 1. FIG. 5 is a sectional view taken along the line V-V in FIG. 4. FIG. 6 is a partially cutaway side view showing a main part of a telescoping drive mechanism of the electric steering apparatus 101 of Embodiment 1.

As is shown in FIGS. 2A to 3, the electric steering apparatus 101 of the invention includes a vehicle body mounting upper bracket 2, a lower column (an outer column) 3, and an upper column (an inner column) 4.

In the vehicle body mounting upper bracket 2 at the vehicular rear side, an upper plate 21 thereof is fixed to the vehicle body 11 with bolts 13. Brackets 31 are formed integrally at an vehicular front side end portion of the lower column 3, and the brackets 31 and a vehicle body mounting lower bracket 12 are connected together by a tilt center shaft 32.

The vehicle body mounting lower bracket 12 is fixed to the vehicle body 11 with bolts 14. The front end portion of the hollow cylindrical lower column 3 is supported on the vehicle body 11 so as to pivot on the tilt center shaft 32 as a fulcrum so as to adjust its tilt position (oscillate within a plane parallel to the surface of a sheet of paper on which FIG. 2 is drawn). Namely, in the embodiment of the invention, the vehicle body mounting upper bracket 2 and the vehicle body mounting lower bracket 12 are configured as the separate members.

An elongated groove 311, which extends in a longitudinal direction of the vehicle body (a horizontal direction in FIG. 2), is formed in the bracket 31. The elongated groove 311 functions when the column is collapsed. The tilt center shaft 32 is pivotally fitted in this elongated groove 311 for column collapse, whereby when a large impact force is applied to the steering wheel 103 towards the vehicular front side during secondary collision and the vehicle body mounting upper bracket 2 is detached from the vehicle body 11, the bracket 31 (including the lower column 3, the vehicle body mounting upper bracket 2, the upper column 4, and the steering wheel 103) is allowed to move to collapse towards the vehicular front side (to a left-hand side in FIG. 2).

The upper column 4 is fitted in an inner circumference of the lower column 3 so as to adjust a telescopic position thereof (or to slide in parallel with a center axis of the lower column 3). An upper steering shaft 102A is supported rotatably in the upper column 4, and the steering wheel 103 is fixed to a vehicular rear end portion of the upper steering shaft 102A (a right-hand side in FIG. 2).

A lower steering shaft 102B is supported rotatably in the lower column 3, and the lower steering shaft 103B is spline fitted in or on the upper steering shaft 102A. Consequently, the rotation of the upper steering shaft 102A is transmitted to the lower steering shaft 102B.

A vehicular front side (the left-hand side in FIG. 2) of the lower steering shaft 102B is connected to the steering gear 107 (refer to FIG. 1) via the universal joint 104. When the driver turns the steering wheel 103, the lower steering shaft 102B rotates via the upper steering shaft 102A, whereby the turning angles of the steered wheels can be changed.

As is shown in FIGS. 2A to 3, the upper plate 21 of the vehicle body mounting upper bracket 2 is fixed to the vehicle body 11 with the bolts 13, 13 via coated plates 25, 25 which are made by bending thin plates substantially into a U shape. The coated plates 25, 25 are mounted with their open sides of the U shapes oriented towards the vehicular front side (the left-hand side in FIG. 2). The coated plates 25, 25 are made up of the thin plates which are coated with a material having a small friction coefficient.

Consequently, when a large impact force is applied to the steering wheel towards the front of the vehicle body during a secondary collision, the coated plates 25, 25 remain on the vehicle body 11 with the bolts 13, 13, and the vehicle body mounting upper bracket 2 is allowed to be easily detached from the coated plates 25, 25 to move towards the vehicular front side.

A left-hand side plate 22 and a right-hand side plate 23 are formed on the upper plate 21 of the vehicle body mounting upper bracket 2 so as to extend downwards in parallel from the upper plate 21. A left-hand side surface 33 and a right-hand side surface 34 of the lower column are slidably held between inner surfaces 221, 231 of the left-hand side plate 22 and the right-hand side plate 23.

In addition, lower ends of the left-hand side plate 22 and the right-hand side plate 23 are connected by a lower plate 24, whereby a closed rectangular shape is formed by the upper plate 21, the left-hand side plate 22, the right-hand side plate 23 and the lower plate 24, so as to increase the rigidity of the vehicle body mounting upper bracket 2.

As is shown in FIGS. 4, 5, a tilt drive mechanism 6 for adjusting the tilt position of the lower column 3 is mounted on the left-hand side surface 33 of the lower column 3. In addition, as is shown in FIG. 6, a telescopic drive mechanism 5 is mounted on a lower surface 35 of the lower column 3.

The tilt drive mechanism 6 shown in FIGS. 4, 5 will be described below. A left-hand reinforcement plate 26 is formed on a left-hand side surface of the vehicle body mounting upper bracket 2 at a right end side of the vehicle body mounting upper bracket 2 as viewed in FIG. 4 so as to be integrally jointed thereto while intersecting the upper plate 21 and the left-hand side plate 22 at right angles and to extend sideways from the left-hand side plate 22.

Similarly, a right-hand reinforcement plate 27 is formed on a right-hand side surface of the vehicle body mounting upper bracket 2 at a right end side of the vehicle body mounting upper bracket 2 as viewed in FIG. 4 so as to be integrally jointed thereto while intersecting the upper plate 21 and the right-hand side plate 23 at right angles and to extend sideways from the right-hand side plate 23.

The lower column 3 extends further rightwards than right-hand edges of the left-hand side plate 22 and the right-hand side plate 23 at a right end thereof in FIG. 4, so that the lower column 3 can tilt freely in a vertical direction within the space defined by the left-hand side plate 22 and the right-hand side plate 23 when a tilt position adjustment is carried out.

An angular U-shaped bracket 36 is formed integrally on the left-hand side surface 33 of the lower column 3, and an electric motor 61 is fixed to this bracket 36. In addition, both upper and lower ends of a feed screw 71 are supported rotatably at an upper rotatably supporting portion 36A and a lower rotatably supporting portion 36B of the bracket 36 via rolling element bearings, not shown, respectively.

A worm gear 62 is provided on an output shaft 611 of the electric motor (tilt motor) 61, and a worm wheel 72, which is fixed to a lower end of the feed screw 71, is made to mesh with the worm gear 62. A speed reduction mechanism is made up of the worm wheel 72 and the worm gear 62, and the rotation of the electric motor 61 is reduced in speed by the speed reduction mechanism for transmission to the feed screw 71.

A nut 73 is screwed on the feed screw 71 for transforming a rotational motion of the feed screw 71 into a linear motion. A ball 74 having a spherical projection is formed integrally on a right-hand side of the nut 73 as viewed in FIG. 4. As viewed in FIG. 4, a cylindrical sleeve 75 is formed integrally on a left-hand end face 26A of the left-hand reinforcement plate 26, so that the ball 74 can fit slidably in the sleeve 75 to thereby make up a spherical joint.

A cylindrical bush 76 is interposed between an outer circumference 74B of the ball 74 and an inner circumference 75A of the sleeve 75. A concave spherical surface 76A is formed on an inner circumference of the bush 76 so as to be closely joined to the spherical outer circumference 74B of the ball 74. The bush 76 is preferably made of a synthetic resin having a small friction coefficient or an oil contained bearing material, or is coated with a low friction material, or is filled with grease in order for the ball 74 to be allowed to rotate smoothly along the concave spherical surface 76a.

There occurring a necessity to adjust the tilt position of the steering wheel 103, when a switch, not shown, is operated, the electric motor 61 is driven to rotate either forwards or backwards. Then, the rotation of the electric motor 61 is reduced in speed for transmission from the worm gear 62 to the worm wheel 72, so that the feed screw 71, which is integrated with the worm wheel 72, is caused to rotate, whereby the nut 73 moves, for example, downwards in FIG. 4 along the feed screw 71.

Then, the ball 74, which is integrated with the nut 73, also moves downwards relative to the lower column 3, and due to the ball 74 fitting in the bush 76, the lower column 3 tilts upwards. In addition, when the ball 74 moves upwards, the lower column 3 tilts downwards. Since the ball 74 freely rotates and slides within the concave spherical surface 76A of the bush 76 when the lower column 3 tilts, there emerges no situation in which the tilt motion of the lower column 3 is interrupted or unnecessary stress or friction is produced between the ball 74 and the bush 76.

Next, the telescopic mechanism 5 shown in FIG. 6 will be described below. A rectangular opening 37 is formed in a lower portion of the lower column 3, and a sleeve 75 fixed to the upper column 4 projects downwardly outwards through the opening 37 so formed. When a telescopic position is adjusted, an outer circumference of the sleeve 75 comes into abutment with a front end 37A and a rear end 37B of the opening 37, whereby the opening 37 fulfills a function as a stopper, and the opening 37 also fulfills a function as a rotation stopper which prevents the rotation of the upper column 4 in the rotational direction.

A front rotatably supporting portion 38A and a rear rotatably supporting portion 38B are formed integrally on the lower surface 35 of the lower column 3 at the front and rear of the opening 37 so as to hold the opening 37 therebetween in the longitudinal direction and to project downwards, and both front and rear ends of a feed screw 71 are supported rotatably at the front and rear rotatably supporting portions 38A, 38B via rolling element bearings, not shown. In addition, an electric motor (telescoping motor) 61 is fixed on to the left-hand side surface 33 of the lower column 3.

A worm gear 62 is formed integrally on an output shaft 611 of the electric motor 61, and a worm wheel 72 fixed to a left end of the feed screw 71 is made to mesh with the worm gear 62. A speed reduction mechanism is made up of the worm wheel 72 and the worm gear 62, whereby the rotation of the electric motor 61 is reduced in speed for transmission to the reed screw 71.

A ball 74 having a spherical projection is formed integrally on an upper side of the nut 73, and by the ball 74 fitting slidably in the sleeve 75, a spherical joint is made up. A bush 76, which is configured identically to that of the tilt drive mechanism 6, is interposed between an outer circumference 74B of the ball 74 and an inner circumference 75A of the sleeve 75.

There occurring a necessity to adjust the telescopic position of the steering wheel 103, when a switch, not shown, is operated, the electric motor 61 is driven to rotate either forwards or backwards. Then, the rotation of the electric motor 61 is reduced in speed for transmission from the worm gear 62 to the worm wheel 72, so that the feed screw 71, which is integrated with the worm wheel 72, is caused to rotate, whereby the nut 73 moves, for example, leftwards (towards the vehicular front side) along the feed screw 71.

Then, the ball 74, which is integrated with the nut 73, also moves leftwards, and due to the ball 74 fitting in the bush 76, the upper column 4 slides into the lower column 3 or telescopes leftwards. In addition, the upper column 4 telescopes rightwards, when the ball 74 moves rightwards (towards the vehicular rear side).

Since the ball 74 freely moves and slides within the concave spherical surface 76A of the bush 76 when the upper column 4 telescopes, there emerges no situation in which the telescopic motion of the upper column 4 is interrupted or unnecessary stress or friction is produced between the ball 74 and the bush 76.

In the embodiment that has been described heretofore, while the cylindrical bush 76 is interposed between the outer circumference 74B of the ball 74 and the inner circumference 75A of the sleeve 75, the bush 76 may be omitted so that the outer circumference 74B of the ball 74 directly fits in the inner circumference 75A of the sleeve 75. In addition, while the nut 73 and the ball 74 are formed integrally, they may be formed separately and then be joined together by joining means such as bolts.

As is shown in FIGS. 2A, 2B and 3, first guide surfaces 22A, 23A, which are each formed into an arc shape centered at the tilt center shaft 32, are formed, respectively, on a vehicular rear end face of the left-hand side plate 22 and a vehicular rear end face of the right-hand side plate 23 of the vehicle body mounting upper bracket 2.

A first guided member (a projecting portion) 81A is fixed to the left-hand side surface 33 of the lower column 33 with two bolts 821, 822 in a position which lies further rearwards (rightwards in FIG. 2) than the first guide surface 22A in the longitudinal direction of the vehicle body. Similarly, a first guided member (a projecting portion) 81B is fixed to the right-hand side surface 34 of the lower column 33 with two bolts 821, 822 in a position which lies further rearwards (rightwards in FIG. 2) than the first guide surface 23A in the longitudinal direction of the vehicle body. The first guided members 81A, 81B are formed of a metal material such as aluminum, iron, or magnesium.

Since the first guided members 81A, 81B are fixed to the left-hand side surface 33 and the right-hand side surface 34 of the lower column 3 with the two bolts 821, 822, respectively, the first guided members 81A, 81B can be attached to and detached from the left-hand side surface 33 and the right-hand side surface 34 of the lower column 3, respectively.

Due to this, the vehicle body mounting upper bracket 2 can be assembled on to the lower column 3 in such a state that the two bolts 821, 822 are loosened on either of the side surfaces of the lower column 3 so that the first guided members 81A, 81B are removed from the left-hand side surface 33 and the right-hand side surface 34 of the lower column 3, respectively. Consequently, since there is no projecting portion which would otherwise constitute a disturbance to assembling the vehicle body mounting upper bracket 2 on to the lower column 3 when the vehicle body mounting upper bracket 2 is so assembled, the assembly of the vehicle body mounting upper bracket 2 is facilitated. The first guided members 81A, 81B are each fixed to the lower column 3 with the two bolts 821, 822 after the assembly of the vehicle body mounting upper bracket 2 to the lower column 3 has been completed.

As is shown in FIGS. 2A, 2B, the first guide surfaces 22A, 23A are each formed into an arc shape of a radius of curvature R1 which is centered at the tilt center shaft 32. In addition, a first guided surface 811A is formed on a vehicular front end face of the first guided member 81A. A first guided surface on a vehicular front end face of the first guided member 81B lying on the back side of the lower column 3 has a similar shape. However, since the second guided member 81B is provided on the back side of the lower column 3 and hence is invisible, the detailed description thereof will be omitted. Namely, in the following description, a relationship between the first guide member 22A and the first guided member 81A, which lie on this or near side of the lower column 3, will mainly be described.

The first guided surface 81A is concentric with the first guide surfaces 22A, 22B and is formed into an arc shape which has a radius of curvature R2. The radius of curvature R2 of the first guided surface 811A is made into a radius of curvature which is slightly larger than the radius of curvature R1 of the first guide surfaces 22A, 23A.

In addition, an arc surface 812A, which is concentric with the first guided surface 811A and is formed into an arc shape of a radius of curvature R3, is formed on a vehicular rear end face of the first guided member 81A. The radius of curvature R3 of the arc surface 812A is formed into a radius of curvature which is larger by an extent which is equal to a width W1 of the first guided member 81A than the radius of curvature R2 of the first guided surface 811A.

As is shown in the sectional view in FIG. 2B which is taken along the line IIB-IIB in FIG. 2A, a resin cover 83 having an angular U-shaped cross section is tight fitted on the first guided member 81A with a suitable degree of fitting tightness. The resin cover 83 is tight fitted on the first guided member 81A so as to cover the first guided surface 811A, the arc surface 812A and a left-hand side surface 813A of the first guided member 81A. By this construction, a vehicular front end face 831 of the resin cover 83 comes to be disposed in a sliding gap between the first guide surface 22A and the first guided surface 811A.

As viewed in FIG. 2A, head portions of the bolts 821, 822 are brought into engagement with semi-circular cutouts 832, 833 made in an upper end and a lower end of the resin cover 83. Consequently, the resin cover 83 is prevented from deviating vertically and longitudinally by the head portions of the bolts 821, 822 being brought into engagement with the cutouts made therein once it is fixed in place.

Similarly, as is shown in FIG. 3, an arc surface 812B, which is formed into the arc shape of the radius of curvature R3, is formed on a vehicular rear end face of the first guided member 81B on the back side of the lower column 3. In addition, a resin cover 83 fitted on the first guided member 81B is tight fitted thereon and covers a first guided surface (not shown), the arc surface 812B and a right-hand side surface 813B of the first guided member 81B.

By this construction, a vehicular front end face (not shown) of the resin cover 83 which covers the first guided member 81B on the back side of the lower column 3, also comes to be disposed in a sliding gap between the first guide surface 23A and the first guided surface (not shown) on the back side of the lower column 3.

A resin such as polyamide or polyacetal whose friction coefficient is small and which has superior wear resistance is preferably used as a material for the resin cover 83. Since the resin cover 83 which is molded of such materials is light in weight and is superior in moldability, not only can the overall weight of the steering be decreased but also working costs thereof can be decreased.

There occurring a necessity to adjust the tilt position of the steering wheel 103, when the electric motor 61 (refer to FIG. 4) is driven to rotate forwards or backwards, the lower column 3 tilts upwards or downwards. Then, the front end face 831 of the resin cover 83 having the small friction coefficient tilts slidably along the first guide surface 22A of the left-hand side plate 22 of the vehicle body mounting upper bracket 2.

Consequently, since the front end face 831 is not caught on the first guide surface 22A of the vehicle body mounting upper bracket 2, no abnormal noise is produced, and a smooth tilt position adjustment can be implemented. In addition, at the time of secondary collision, the front end face 831 of the resin cover 83 is brought into collision with the first guide surface 22A of the left-hand side plate 22 of the vehicle body mounting upper bracket 2, whereby an impact force acting towards the front of the vehicle body can be transmitted to the vehicle body mounting upper bracket 2 in an ensured fashion.

### Embodiment 2

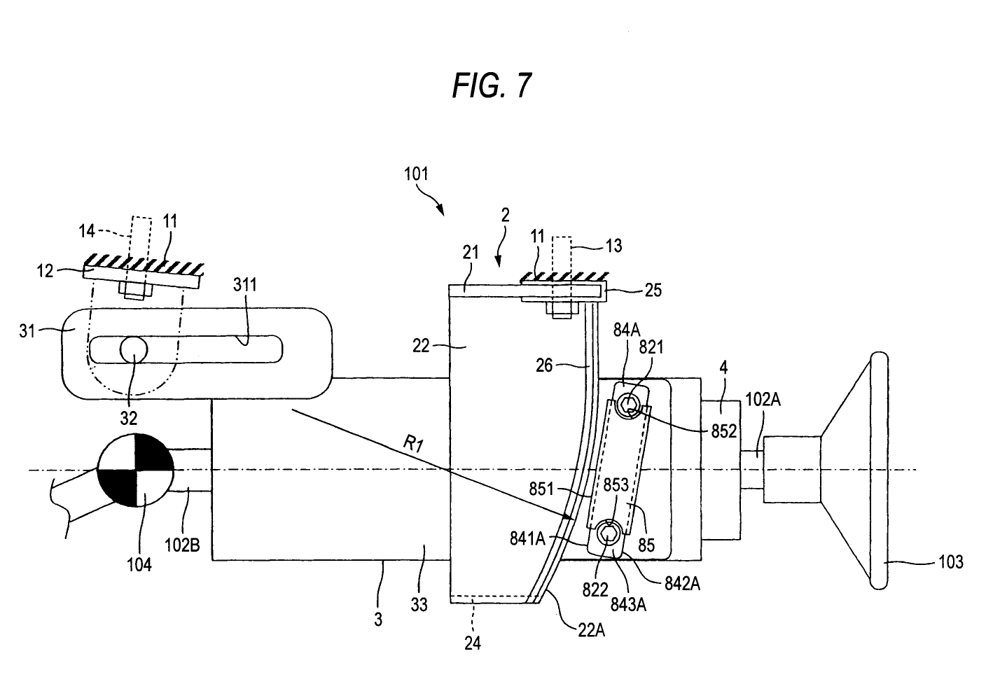

Next, Embodiment 2 of the invention will be described. FIG. 7 is a side view showing a main part of an electric steering apparatus 101 of Embodiment 2 of the invention. In the following description, only constituent structural portions will be described which differ from those of Embodiment 1, and similar descriptions to those of Embodiment 1 will be omitted to avoid the repetition thereof. In addition, like reference numerals will be given to like components to those of Embodiment 1 for description.

In Embodiment 2, an example is illustrated in which a first guided surface of a first guided member is formed into a straight line shape which extends substantially in a tangential direction relative to a first guide surface 22A of a vehicle body mounting upper bracket 2. In the following description, the first guide surface 22A and a first guided member which are shown or visible in FIG. 7 will be described, and the description of a first guide surface 23A and a first guided member will be omitted which lie on a back or invisible side of a lower column 3 and which have the same configurations as those of the first guide surface 22A and the first guided member shown in FIG. 7.

As is shown in FIG. 7, as with Embodiment 1, a first guide surface 22A, which is formed into an arc shape centered at a tilt center shaft 32, is formed on a vehicular rear end face of a left-hand side plate 22 of a vehicle body mounting upper bracket 2.

A first guided member (a projecting portion) 84A is fixed to a left-hand side surface 33 of a lower column 3 with two bolts 821, 822 in a position which lies further rearwards (rightwards in FIG. 7) than the first guide surface 22A in the longitudinal direction of the vehicle body. Since the first guided member 84A is fixed to the left-hand side surface 33 of the lower column 3 with the two bolts 821, 822, the first guided member 84A can be attached to and detached from the left-hand side surface 33 of the lower column 3.

Due to this, the vehicle body mounting upper bracket 2 can be assembled on to the lower column 3 in such a state that the two bolts 821, 822 are loosened so that the first guided member 81A is removed from the left-hand side surface 33 of the lower column 3. Consequently, since there is no projecting portion which would otherwise constitute a disturbance to assembling the vehicle body mounting upper bracket 2 on to the lower column 3 when the vehicle body mounting upper bracket 2 is so assembled, the assembly of the vehicle body mounting upper bracket 2 is facilitated. The first guided member 81A is fixed to the lower column 3 with the two bolts 821, 822 after the assembly of the vehicle body mounting upper bracket 2 to the lower column 3 has been completed.

As is shown in FIG. 7, the first guide surface 22A is formed into an arc shape of a radius of curvature R1 which is centered at the tilt center shaft 32. In addition, a first guided surface 841A is formed on a vehicular front end face of the first guided member 81A. The first guided surface 841A is formed into a straight line shape which extends substantially in a tangential direction relative to the first guide surface 22A.

In addition, a straight-line surface 842A, which is parallel to the first guided surface 841A and is formed into a straight line shape, is formed on a vehicular rear end face of the first guided member 84A.

As with Embodiment 1, a resin cover 85, which has an angular U-shaped cross section, is tight fitted on the first guided member 84A with a suitable degree of fitting tightness. The resin cover 85 is tight fitted on the first guided member 84A so as to cover the first guided surface 841A, the straight-line surface 842A and a left-hand side surface 843A of the first guided member 84A. By this construction, a vehicular front end face 851 of the resin cover 85 comes to be disposed in a sliding gap between the first guide surface 22A and the first guided surface 841A.

Head portions of the bolts 821, 822 are brought into engagement with semi-circular cutouts 852, 853 made in an upper end and a lower end of the resin cover 85. Consequently, the resin cover 85 is prevented from deviating vertically and longitudinally by the head portions of the bolts 821, 822 being brought into engagement with the cutouts made therein once it is fixed in place.

Also in Embodiment 2, when the lower column 3 tilts upwards or downwards in order to adjust the tilt position of the steering wheel 103, the front end face 851 of the resin cover 85 having the small friction coefficient tilts slidably along the first guide surface 22A of the left-hand side plate 22 of the vehicle body mounting upper bracket 2.

Consequently, since the front end face 851 is not caught on the first guide surface 22A of the vehicle body mounting upper bracket 2, no abnormal noise is produced, and a smooth tilt position adjustment can be implemented. In addition, at the time of secondary collision, the front end face 851 of the resin cover 85 is brought into collision with the first guide surface 22A of the left-hand side plate 22 of the vehicle body mounting upper bracket 2, whereby an impact force acting towards the front of the vehicle body can be transmitted to the vehicle body mounting upper bracket 2 in an ensured fashion. In Embodiment 2, since the first guided member 84A and the resin cover 85 are each formed into the straight-line shape, the configuration is made simple, thereby making it possible to reduce the production costs of the steering apparatus.

### Embodiment 3

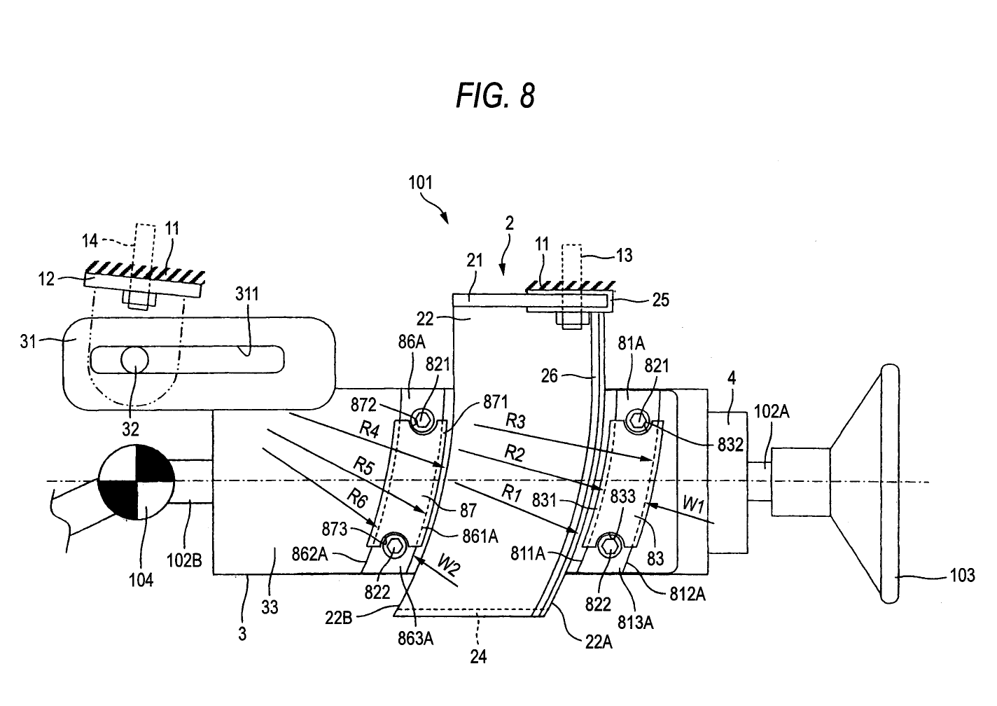

Next, Embodiment 3 of the invention will be described. FIG. 8 is a side view showing a main part of an electric steering apparatus 101 of Embodiment 3 of the invention. In the following description, only constituent structural portions will be described which differ from those of the embodiments that have been described above, and similar descriptions to those of the embodiments will be omitted to avoid the repetition thereof. In addition, like reference numerals will be given to like components to those of the embodiments for description.

In Embodiment 3, an example is illustrated in which a second guide surface, which is formed into an arc shape, is formed additionally on a vehicular front end face of a left-hand side plate 22 of a vehicle body mounting upper bracket 2, and a second guided member having a second guided surface which is adapted to slide along the second guide surface so formed when the tilt position of a lower column 3 is adjusted is additionally formed on a lateral side surface of the lower column 3.

In the following description, a first guide surface 22A and the second guided member which are shown or visible in FIG. 8 will be described, and the description of a first guide surface 23A and a second guided member will be omitted which lie on a back or invisible side of a lower column 3 and which have the same configurations as those of the first guide surface 22A and the second guided member shown in FIG. 8.

As is shown in FIG. 8, a second guide surface 22B, which is formed into an arc shape which is centered at a tilt center shaft 32, is additionally formed on a vehicular front end face of a left-hand side plate 22 of a vehicle body mounting upper bracket 2.

A second guided member (a projecting portion) 86A is fixed to a left-hand side surface 33 of a lower column 3 with two bolts 821, 822 in a position lying further forwards than the second guided surface 22B in the longitudinal direction of the vehicle body (leftwards as viewed in FIG. 8). The second guided member 86 is formed of a metal material such as aluminum, iron, or magnesium.

Since the second guided member 86A is fixed to the left-hand side surface 33 of the lower column 3 with the two bolts 821, 822, the second guided member 86A can be attached to and detached from the left-hand side surface 33 of the lower column 3.

Due to this, the vehicle body mounting upper bracket 2 can be assembled on to the lower column 3 in such a state that the front and rear pairs of two bolts 821, 822 on the left-hand side plate 22 are loosened so that a first guided member 81A and the second guided member 86A are removed from the left-hand side surface 33 of the lower column 3. Consequently, since there is no projecting portion which would otherwise constitute a disturbance to assembling the vehicle body mounting upper bracket 2 on to the lower column 3 when the vehicle body mounting upper bracket 2 is so assembled, the assembly of the vehicle body mounting upper bracket 2 is facilitated.

The first guided member 81A and the second guided member 86A are fixed to the lower column 3 with the front and rear pairs of two bolts 821, 822 after the assembly of the vehicle body mounting upper bracket 2 to the lower column 3 has been completed.

As is shown in FIG. 8, the second guide surface 22B is formed into the arc shape of a radius of curvature R4 which is centered at the tilt center shaft 32. In addition, a second guided surface 861A is formed on a vehicular rear end face of the second guided member 86A.

The second guided surface 861A is concentric with the second guide surface 22B and is formed into an arc shape which has a radius of curvature R5. The radius of curvature R5 of the second guided surface 861A is formed into a radius of curvature which is slightly larger than a radius of curvature R4 of the second guide surface 22B.

In addition, an arc surface 862A, which is concentric with the second guided surface 861A and is formed into an arc shape of a radius of curvature R6, is formed on a vehicular front end face of the second guided member 86A. The radius of curvature R6 of the arc surface 862A is formed larger by an extent which is equal to a width W2 of the second guided member 86A than the radius of curvature R5 of the second guided surface 861A.

As with Embodiment 1, a resin cover 87, which has an angular U-shaped cross section, is tight fitted on the second guided member 86A with a suitable degree of fitting tightness. The resin cover 87 is tight fitted on the second guided member 86A so as to cover the second guided surface 861A, the arc surface 862A and a left-hand side surface 863A of the second guided member 86A. By this construction, a vehicular rear end face 871 of the resin cover 87 comes to be disposed in a sliding gap between the second guide surface 22B and the second guided surface 861A.

Head portions of the bolts 821, 822 are brought into engagement with semi-circular cutouts 872, 873 made in an upper end and a lower end of the resin cover 87. Consequently, the resin cover 87 is prevented from deviating vertically and longitudinally by the head portions of the bolts 821, 822 being brought into engagement with the cutouts made therein once it is fixed in place. The material of the resin cover 87 is the same as the resin cover 83 of Embodiment 1.

When the lower column 3 tilts upwards or downwards in order to adjust the tilt position of the steering wheel 103, a vehicular front end face 831 of the resin cover 83 having the small friction coefficient tilts slidably along the first guide surface 22A of the vehicle body mounting upper bracket 2. At the same time as this occurs, the rear end face 871 of the resin cover 87 tilts slidably along the second guide surface 22B of the vehicle body mounting upper bracket 2.

In this way, the first resin cover 83 and the second resin cover 87 tilt slidably while holding therebetween the first guide surface 22A and the second guide surface 22B by the front end face 831 of the resin cover 83 and the rear end face 871 of the resin cover 87, which both have the small friction coefficient. Consequently, the front end face 831 and the rear end face 871 are guided smoothly by the first guide surface 22A and the second guide surface 22B of the vehicle body mounting upper bracket 2, whereby a smooth tilt position adjustment can be implemented without producing any abnormal noise.

In addition, at the time of secondary collision, the front end face 831 of the resin cover 83 is brought into collision with the guide surface 22A of the left-hand side plate 22 of the vehicle body mounting upper bracket 2, and the vehicle body mounting upper bracket 2 is held by the front end face 831 of the resin cover 83 and the rear end face 871 of the resin cover 87, whereby the impact force acting towards the front of the vehicle body can be transmitted to the vehicle body mounting upper bracket 2 in an ensured fashion.

### Embodiment 4

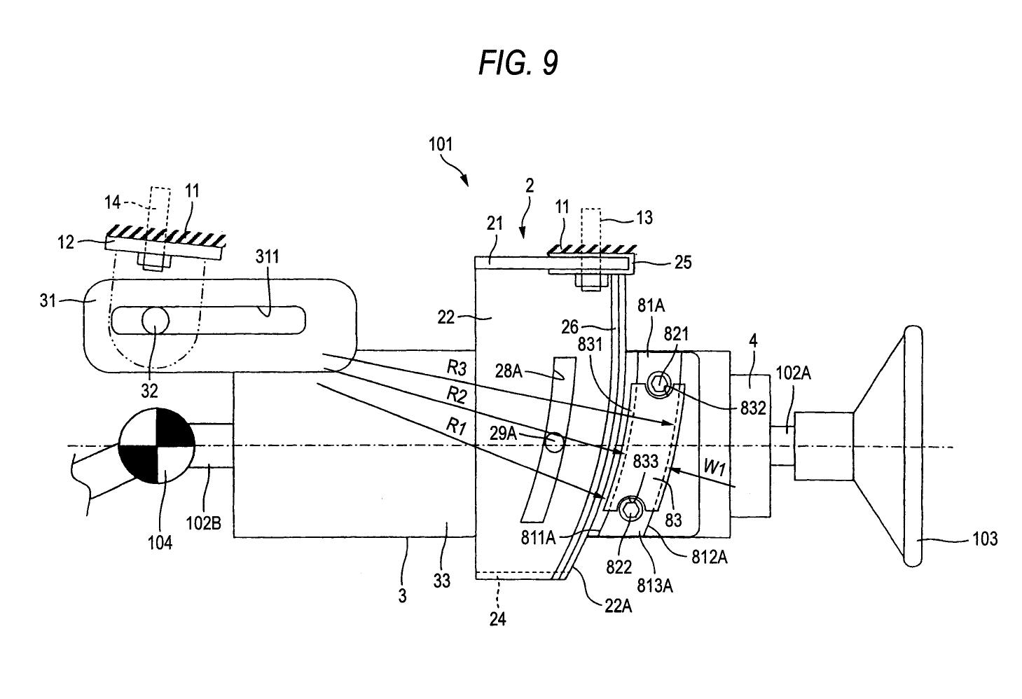

Next, Embodiment 4 of the invention will be described. FIG. 9 is a side view showing a main part of an electric steering apparatus 101 of Embodiment 4 of the invention. In the following description, only constituent structural portions will be described which differ from those of the embodiments that have been described above, and similar descriptions to those of the embodiments will be omitted to avoid the repetition thereof. In addition, like reference numerals will be given to like components to those of the embodiments for description.

In Embodiment 4, an example is illustrated in which arc-shaped elongated grooves centered at a tilt center shaft 32 of a lower column 3 are formed in a left-hand side plate 22 and a right-hand side plate 23 of a vehicle body mounting upper bracket 2 and third guided members are formed on lateral side surfaces of the lower column so as to slide along the elongated grooves, respectively, when a tilt position adjustment is carried out.

In the following description, the left-hand side plate 22 and the third guided member which are shown or visible in FIG. 9 and a first guide surface 22A and a second guided member which are shown or visible in FIG. 9 will be described, and the description will be omitted of the right-hand side plate 23 and the third guided member which lie on a back side or invisible side of the lower column 3 in FIG. 9 and have the same configurations as the corresponding side plate and third guided member on the visible side in FIG. 9 and a first guide surface 23A and a second guided member which lie on the back side or invisible side of the lower column 3 in FIG. 9 and have the same configurations as the corresponding guide surface and second guided member on the visible side in FIG. 9.

As is shown in FIG. 9, an elongated groove 28A, which is formed into an arc shape centered at a tilt center shaft 32, is formed on a left-hand side plate 22 of a vehicle mounting upper bracket 2 in a position lying further forwards than a first guide surface 22A in the longitudinal direction of the vehicle body.

A cylindrical third guided member 29A is formed on a left-hand side surface 33 of a lower column 3 so as to project therefrom, and the third guided member 29A so formed then fits in the elongated groove 28A, so that the third guided member 29A slides while being guided by the elongated groove 28A when the tilt position of the lower column 3 is adjusted. After the assembling work of the vehicle body mounting upper bracket 2 on to the lower column 3 has been completed, a bolt is screwed into the left-hand side surface 33 of the lower column 3 and a cylindrical head portion of the bolt so screwed is preferably used as the third guided member 29A.

There occurring a necessity to adjust the tilt position of a steering column 103, when the lower column 3 tilts upwards or downwards, a vehicular front end face 831 of a resin cover 83 having a small friction coefficient tilts slidably along the first guide surface 22A of the vehicle body mounting upper bracket 2. At the same time as this occurs, the third guided member 29A tilts slidably along the elongated groove 28A.

In this way, the front end face 831 of the resin cover 83 having the small friction coefficient and the third guided member 29A are allowed to tilt slidably along the first guide surface 22A and the elongated groove 28A of the vehicle body mounting upper bracket 2, respectively. Consequently, a smooth tilt position adjustment can be implemented without producing any abnormal noise by the front end face 831 and the third guided member 29A being guided smoothly by the first guide surface 22A and the elongated groove 28A of the vehicle body mounting upper bracket 2.

In addition, at the time of secondary collision, the front end face 831 of the resin cover 38 is brought into collision with the first guide surface 22A of the left-hand side plate 22 of the vehicle body mounting upper bracket 2, and the vehicle body mounting upper bracket 2 is held by the front end face 831 of the resin cover 83 and the third guided member 29A therebetween, whereby impact force acting towards the front of the vehicle body can be transmitted to the vehicle body mounting upper bracket 2 in an ensured fashion.

### Embodiment 5

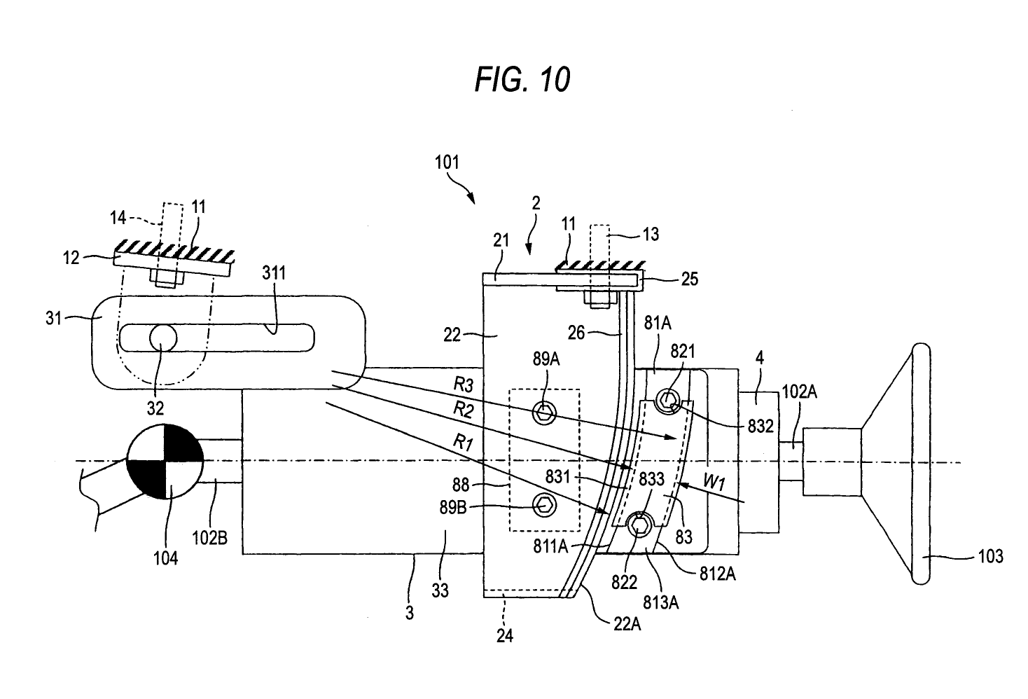

Next, Embodiment 5 of the invention will be described. FIG. 10 is a side view showing a main part of an electric steering apparatus 101 of Embodiment 5 of the invention. In the following description, only constituent structural portions will be described which differ from those of the embodiments that have been described above, and similar descriptions to those of the embodiments will be omitted to avoid the repetition thereof. In addition, like reference numerals will be given to like components to those of the embodiments for description.

In Embodiment 5, an example is illustrated in which a spacer is interposed between an inner surface of either a left-hand side plate 22 or a right-hand side plate 23 of a vehicle mounting upper bracket 2 and a lateral side surface of a lower column 3.

In the following description, an example will be described in which a spacer is interposed between an inner surface 221 (refer to FIG. 3) of the left-hand side plate 22 and a left-hand side surface 33 of the lower column 3 which are shown or visible in FIG. 10, and the description will be omitted of an example in which a spacer is interposed between an inner surface 231 (refer to FIG. 3) of the right-hand side plate 23 and a right-hand side surface 34 of the lower column 3 which lie on a back or invisible side of the lower column 3 in FIG. 10.

As is shown in FIG. 10, a rectangular thin plate-like spacer 88 is interposed between an inner surface 221 (refer to FIG. 3) of a left-hand side plate 22 of a vehicle body mounting upper bracket 2 and a left-hand side surface 33 of a lower column 3 in a position lying further forwards than a first guide surface 22A of the left-hand side plate 22 in the longitudinal direction of the vehicle body.

Adjustment screws 89A, 89B are screwed into the left-hand side plate 22 from a near side to a far side of FIG. 10 so as to intersect the surface of a sheet of paper on which FIG. 10 is drawn at right angles, so as to push the spacer 88 towards the left-hand side surface 33 of the lower column 3 under a suitable pressure.

There occurring a necessity to adjust the tilt position of a steering wheel 103, when the lower column 3 tilts upwards or downwards, a vehicular front end face 831 of a resin cover 83 having a small friction coefficient tilts slidably along the first guide surface 22A of the vehicle body mounting upper bracket 2.

At the same time as this occurs, the spacer 88 functions to eliminate looseness in a gap constituting a tilt sliding portion between the left-hand side surface 33 of the lower column 3 and the inner surface 221 of the left-hand side plate 22 of the vehicle body mounting upper bracket 2.

In this way, since the tilt sliding resistance due to tilt angle is held constant by the spacer 88 at the same time that the front end face 831 of the resin cover 83 having the small friction coefficient tilts slidably along the first guide surface 22A of the vehicle body mounting upper bracket 2, a smooth tilt position adjustment can be implemented without producing any abnormal noise.

In the embodiments, while the first guided members 81A, 81B, 84A and the second guided member 86A are detachably mounted on the lower column 3 with the bolts 821, 822, the fixing means is not limited to the bolts 821, 822, tapped screws may be used. In addition, raised portions may be formed on either the first guided members 81A, 81B, 84A and the second guided member 86A or the lower column 3 and recessed portions into which the raised portions can fit may be formed on the other, so that the raised portions and the recessed portions can be fitted together.

While the left-hand side surface 33 and the right-hand side surface 34 of the lower column 3 are formed into the smooth flat surfaces so as to tilt slidably along the inner surfaces 221, 222, in the case of Embodiment 5 in which the lower column 3 tilts slidably along the spacers 88, only tilt sliding ranges on the lateral side surfaces of the lower column 3 where the lower column 3 tilts slidably along the spacers 88 may be formed into smooth flat surfaces.

Furthermore, in the embodiments, while the lower column 3 and the upper column 4 are made to make up the outer column and the inner column, respectively, the lower column 3 and the upper column 4 may be made to make up an inner column and an outer column, respectively.

In addition, in the embodiments of the invention, while the invention is described as being applied to the tilt and telescoping type electric steering apparatus in which both tilt position adjustment and telescoping position adjustment can be implemented, the invention may be applied to a tilt type electric steering apparatus in which only the tilt position adjustment is enabled. Furthermore, the invention may be applied to an electric steering apparatus in which a vehicle body mounting upper bracket 2 and a vehicle body mounting lower bracket 12 are formed into a single vehicle body mounting bracket.

What is claimed is:

1. A steering apparatus comprising:
a vehicle body mounting bracket adapted to be mounted on a vehicle body;
a column which is supported on left- and right-hand side plates of the vehicle body mounting bracket so as to tilt slidably;
a steering shaft which is supported rotatably in the column and on which a steering wheel is mounted at a vehicular rear side;
a tilt motor;
a tilt drive mechanism for adjusting a tilt position of the column by virtue of a driving force of the tilt motor;
first guide surfaces which are formed on vehicular rear end faces of the side plates and are each formed into an arc shape centered at a tilt center shaft of the column; and
first guided members which are formed on lateral sides of the column and which have first guided surfaces,
wherein the first guided surfaces slide along the first guide surfaces, respectively, at the time of adjusting tilt position of the column.

2. The steering apparatus as set forth in claim 1, further comprising first resin covers covering the first guided member and interposed in sliding gaps between the first guide surfaces and the first guided surfaces.

3. The steering apparatus as set forth in claim 1, wherein
the vehicle body mounting bracket comprises:
a vehicle body mounting lower bracket which supports a lower side of the column on the vehicle body so as to pivot about the tilt center shaft as a fulcrum; and
a vehicle body mounting upper bracket which is configured as a separate element from the vehicle body mounting lower bracket and is adapted to mount an upper side of the column on the vehicle body,
wherein the column is held between left- and right-hand side plates of the vehicle body mounting upper bracket so as to tilt slidably.

4. The steering apparatus as set forth in claim 2, wherein the vehicle body mounting bracket comprises:
a vehicle body mounting lower bracket which supports a lower side of the column on the vehicle body so as to pivot about the tilt center shaft as a fulcrum; and
a vehicle body mounting upper bracket which is configured as a separate element from the vehicle body mounting lower bracket and is adapted to mount an upper side of the column on the vehicle body; and wherein
the column is held between left- and right-hand side plates of the vehicle body mounting upper bracket so as to tilt slidably.

5. The steering apparatus as set forth in claim 1, wherein
the first guided members are mounted detachably on the column.

6. The steering apparatus as set forth in claim 2, wherein
the first guided members are mounted detachably on the column.

7. The steering apparatus as set forth in claim 3, wherein
the first guided members are mounted detachably on the column.

8. The steering apparatus as set forth in claim 4, wherein
the first guided members are mounted detachably on the column.

9. The steering apparatus as set forth in claim 1, wherein
the first guided surface is concentric with the first guide surface and is formed into an arc shape which has a radius of curvature which is slightly larger than the first guide surface.

10. The steering apparatus as set forth in claim 1, wherein
the first guided surface is formed into a straight line shape which extends substantially in a tangential direction relative to the first guide surface.

11. The steering apparatus as set forth in claim 1, further comprising:
second guide surfaces which are formed on end faces of the side plates which face the front of the vehicle body and are each formed into an arc shape centered at the tilt center shaft of the column;
second guided members which are formed on the lateral sides of the column and which have second guided surfaces adapted to slide along the second guide surfaces, respectively, when the column is adjusted with respect to its tilt position; and
second resin covers covering the second guided members and interposed in sliding gaps between the second guide surfaces and the second guided surfaces.

12. The steering apparatus as set forth in claim 11, wherein
the second guided members are mounted detachably on the column.

13. The steering apparatus as set forth in claim 1, further comprising:
elongated grooves which are formed on the side plates and are each formed into an arc shape centered at the tilt center shaft of the column; and
third guided members which are formed on the lateral sides of the column and are adapted to along the elongated grooves, respectively, at the time of adjusting the tilt position of the column.

14. The steering apparatus as set forth in claim 1, further comprising:
a spacer interposed between either of the left- and right-hand side plates and the lateral side of the column; and
an adjustment screw which is provided on the side plate, so as to push the spacer towards the lateral side of the column.
